(19) United States
(12) Patent Application Publication
(10) Pub. No.: US 2004/0175182 A1
(43) Pub. Date: Sep. 9, 2004

(54) Remote controller

(76) Inventor: Peter Kuo, San Jose, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/382,529

(22) Filed: Mar. 7, 2003

(51) Int. Cl. H04B 10/00

(52) U.S. Cl. 398/140

(57) ABSTRACT

A remote controller is constructed to include a vertical housing holding a remote control circuit board on the inside for positioning on a flat surface in vertical, a set of volume control buttons and channel selector buttons mounted on the housing and electrically connected to the remote control circuit board for volume control and channel selection control, and an emitter unit, the emitter unit having a light-admitting top cover mounted on the top side of the housing, and a vertical LED and a plurality of horizontal LEDs arranged inside the top cover and controlled by the remote control circuit board to emit signal-carried light through the top cover in different directions.

### BACKGROUND OF THE INVENTION

1. Field of the Invention

The present invention relates to a remote controller for controlling the operation of an electric appliance at a distance and, more particularly, to a vertical remote controller that stands still as a tabletop ornamental item when placed on a plate surface.

2. Description of the Related Art

FIG. 7 illustrates a conventional remote controller 4 for controlling the operation of an electric appliance, for example, a TV, an air-conditioner, or the like. This structure of remote controller 4 has a flat, rectangular shape. The remote controller 4 comprises an emitter 43 provided at the front side, and a plurality of operation control buttons including number entry keys 41 and function keys 42 located on the top side. This design of remote controller 4 has numerous drawbacks as follows:

1. To some people, more particularly aged persons and young children, it is difficult to remember the positions and functioning of the number entry keys 41 and the function keys 42. Some people can never learn how to use the remote controller 4.

2. When using the remote controller 4, the user must aim the emitter 43 of the remote controller 4 at the electric appliance to be controlled.

3. The remote controller 4 does not provide any other added value, and must be well received when not in use.

### SUMMARY OF THE INVENTION

The present invention has been accomplished under the circumstances in view. It is one object of the present invention to provide a remote controller, which is easy to operate. It is another object of the present invention to provide a remote controller, which can be used as an indoor ornamental item. According to one aspect of the present invention, the remote controller comprises a vertical housing that can be positioned on a flat surface in vertical. According to another aspect of the present invention, the remote controller comprises a set of volume control buttons and a set of channel selection buttons for volume and channel selection controls respectively. According to still another aspect of the present invention, the emitter of the remote controller comprises a vertical LED and a plurality of horizontal LEDS radially arranged around the vertical LED for emitting signal-carried light in different directions. According to still another aspect of the present invention, the remote controller has a top cover provided at the top side of the housing and adapted to detachably hold one of a set of ornamental items.

### BRIEF DESCRIPTION OF THE DRAWINGS

FIG. 1 is an exploded view of a remote controller according to the present invention.

FIG. 2 is a side view in section of the remote controller according to the present invention.

FIG. 3 is a top plain view of the remote controller according to the present invention.

FIG. 4 is an oblique elevation of the remote controller according to the present invention.

FIG. 5 is another oblique elevation of the remote controller when viewed from another angle according to the present invention.

FIG. 6 is a schematic drawing showing a variety of ornamental items mountable on the remote controller selectively

FIG. 7 is an elevational view of a remote controller according to the prior art

### DETAILED DESCRIPTION OF THE PREFERRED EMBODIMENT

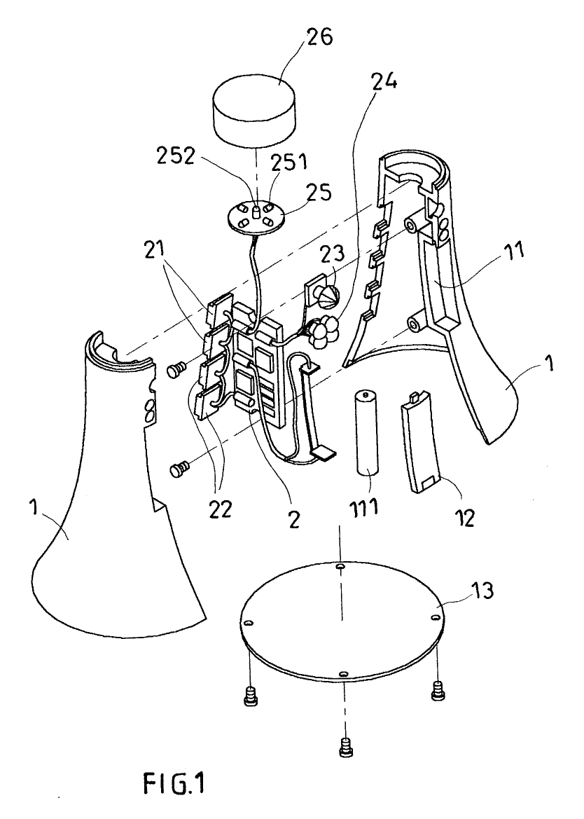

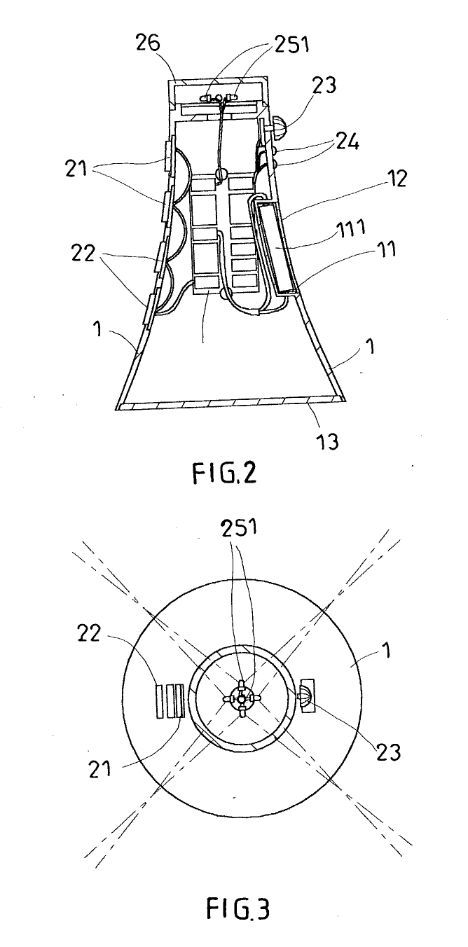

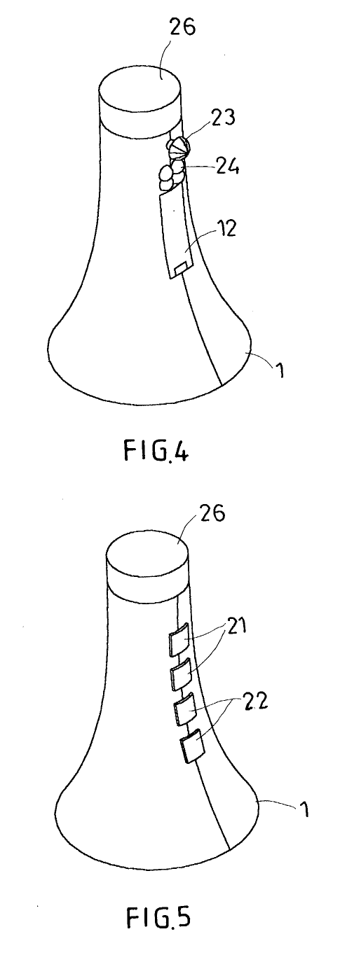

Referring to FIGS. 1-5, a remote controller is shown comprising a vertical housing 1, a remote control circuit board 2 mounted inside the vertical housing 1, volume control buttons 21 and channel selection buttons 22 mounted on one side of the vertical housing 1 and electrically connected to the remote control circuit board 2, a battery 111 mounted in a battery chamber 11 at one side of the vertical housing 1 and electrically connected to the remote control circuit board 2 to provide the necessary working voltage, a battery lid 12 adapted to cover the battery chamber 11, a flat bottom cover 13 fixedly fastened to the bottom side of the vertical housing 1 for supporting the remote controller stably on a flat surface, for example, the top of a desk, an emitter 25 provided at the top side of the housing 1 and electrically connected to the remote control circuit board 2, and a top cover 26 covering the top side of the housing 1 to protect the emitter 25. The top cover 26 admits light. The emitter 25 comprises a vertical LED (light emitting diode 252 perpendicularly aimed at the center of the top cover 26, and a plurality of horizontal LEDs (light emitting diodes) 251 radially arranged around the vertical LED 252 and aimed at the periphery of the top cover 26 The remote controller further comprises a screen regulator 23 and selector buttons 24 mounted on the housing 1 at one side opposite to the volume control buttons 21 and channel selection buttons 22 and electrically connected to the remote control circuit board 2. The screen regulator 23 is for screen horizontal/vertical alignment control. The selector buttons 24 are for TV, DVD, AUX (controls the receiver), SAT (satellite receiver), Cable box selection control.

When operating the remote controller, the control signal is carried by light emitted by the horizontal LEDs 251 and the vertical LED 252, i.e., the control signal is accessible to a predetermined distance in different directions around the housing 1. Therefore, the user can operate the remote controller to control an electric appliance without moving the remote controller or aiming the remote controller at the electric appliance to be controlled.

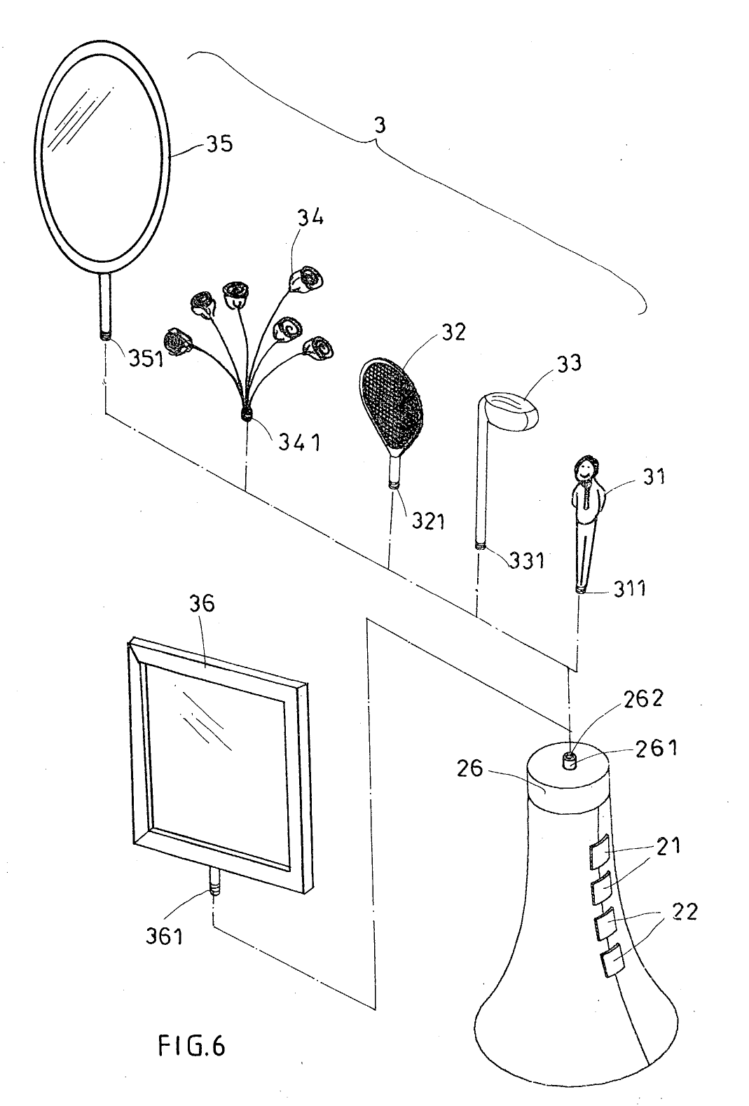

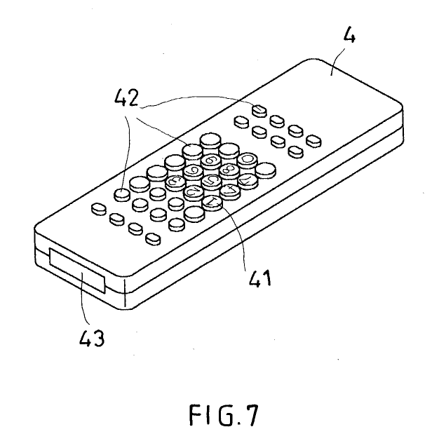

Referring to FIG. 6, the top cover 26 can be made having a top rod 261 and a mounting screw hole 262 in the top rod 261 for the mounting of any of a variety of ornamental items 3, for example, a toy Oscar Statuette 31, a toy racket 32, a top golf club 33, a bundle of flowers 34, a mirror 35, a picture frame 36, etc. Each ornamental item has a threaded bottom mounting rod 311, 321, 331, 341, 351, 361 connectable to the mounting screw hole 262 of the top rod 261 of the top cover 26.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A remote controller comprising:
a housing to be positioned on a flat surface in vertical;
a remote control circuit board mounted inside said housing for controlling the operation of an electric appliance;
a set of volume control buttons mounted on said housing at one side and electrically connected to said remote control circuit board for volume control;
a set of channel selector buttons mounted on said housing at one side and electrically connected to said remote control circuit board for channel selection control; and
an emitter unit, said emitter unit comprising a top cover mounted on a top side of said housing, said top cover admitting light, and a plurality of first light emitting diodes horizontally and radially arranged inside said top cover and controlled by said remote control circuit board to emit signal-carried light through said top cover.

2. The remote controller as claimed in claim 1 wherein said emitter further comprises a second light emitting diode vertically arranged inside said top cover and surrounding by said first light emitting diodes.

3. The remote controller as claimed in claim 1 further comprising a screen regulator and a set of selector buttons mounted on said housing at one side opposite to said volume control buttons and said channel selection buttons and electrically connected to said remote control circuit board for screen horizontal/vertical alignment control and for TV, DVD, AUX (controls the receiver), SAT (satellite receiver), Cable box selection control respectively.

4. A remote controller comprising
a housing to be positioned on a flat surface in vertical;
a remote control circuit board mounted inside said housing for controlling the operation of an electric appliance;
a set of volume control buttons mounted on said housing at one side and electrically connected to said remote control circuit board for volume control;
a set of channel selector buttons mounted on said housing at one side and electrically connected to said remote control circuit board for channel selection control;
an emitter mounted on a top side of said housing, said emitter comprising a vertical light emitting diode and a plurality of horizontal light emitting diodes radially arranged around said vertical light emitting diode, said vertical light emitting diode and said horizontal light emitting diodes being electrically connected to said remote control circuit board and controlled by said remote control circuit board to emit signal-carried light through said top cover; and
a top cover covered on said housing over said emitter, said top cover admitting light.

5. A remote controller comprising:
a housing to be positioned on a flat surface in vertical;
a remote control circuit board mounted inside said housing for controlling the operation of an electric appliance;
a set of volume control buttons mounted on said housing at one side and electrically connected to said remote control circuit board for volume control;
a set of channel selector buttons mounted on said housing at one side and electrically connected to said remote control circuit board for channel selection control;
an emitter mounted on a top side of said housing, said emitter comprising a vertical light emitting diode and a plurality of horizontal light emitting diodes radially arranged around said vertical light emitting diode, said vertical light emitting diode and said horizontal light emitting diodes being electrically connected to said remote control circuit board and controlled by said remote control circuit board to emit signal-carried light through said top cover;
a top cover covered on said housing over said emitter, said top cover admitting light, said top cover having a top rod and a mounting screw hole in said top rod; and
an ornamental item connectable to said top cover, said ornamental item having a threaded bottom mounting rod for threading into the mounting screw hole of the top rod of said top cover.

6. The remote controller as claimed in claim 5 wherein said ornamental item is a toy Oscar Statuette.

7. The remote controller as claimed in claim 5 wherein said ornamental item is a toy sports gear.

8. The remote controller as claimed in claim 5 wherein said ornamental item is a mirror.

9. The remote controller as claimed in claim 5 wherein said ornamental item is a picture frame.

10. The remote controller as claimed in claim 5 further comprising a screen regulator and a set of selector buttons mounted on said housing at one side opposite to said volume control buttons and said channel selection buttons and electrically connected to said remote control circuit board for screen horizontal/vertical alignment control and for TV, DVD, AUX (controls the receiver), SAT (satellite receiver), Cable box selection control respectively.
